(19) United States
(12) Patent Application Publication
(10) Pub. No.: US 2022/0312119 A1
(43) Pub. Date: Sep. 29, 2022

(54) MOVING MAGNET ACTUATOR WITH VOICE COIL

(71) Applicant: Google LLC, Mountain View, CA (US)

(72) Inventor: James Marchant, Los Gatos, CA (US)

(21) Appl. No.: 17/615,232

(22) PCT Filed: Dec. 18, 2019
(86) PCT No.: PCT/US2019/067072

§ 371 Date: Nov. 30, 2021

(51) Int. Cl. H04R 7/04; H04R 9/02

(52) U.S. Cl. CPC H04R 7/04; H04R 9/022; H04R 2499/11; H04R 2499/15

(57) ABSTRACT

An actuator includes a voice coil and a moving magnet assembly. The coil is attached to a panel extending in a plane. A first portion of the coil includes a first set of windings arranged in a spiral extending parallel to the plane. The first set of windings spans a first dimension in a first direction parallel to the plane. The first set of windings is attached to the panel. A second portion of the coil includes a second set of windings extending perpendicular to the plane. The second set of windings spans a second dimension in the first direction. The first dimension is larger than the second dimension. The magnet assembly is suspended from the panel, and includes a magnet positioned within the second portion of the coil. The magnet assembly is configured to vibrate in a second direction perpendicular to the plane during operation of the actuator.

### TECHNICAL FIELD

This disclosure relates generally to moving magnet actuators, and specifically to voice coils of moving magnet actuators for panel audio transducers.

### BACKGROUND

A moving magnet actuator for a panel audio transducer of a mobile device typically includes a coil of an electrically-conducting material, often referred to as a voice coil, and a magnet suspended close to the coil. The voice coil is often attached to a panel, such as a display panel. When alternating current is passed through the voice coil, the coil generates a magnetic field which causes the magnet to move. The vibrations from the moving magnet are coupled to the panel, which vibrates to generate audio. During this process, the passage of alternating current through the voice coil heats up the voice coil. When the voice coil is attached to the panel, the panel is heated locally at and around the place of attachment between the voice coil and the panel. When the panel is a display panel, for example, such localized heating of the display panel can undesirably distort the display (e.g., modify the hue of displayed images) around such place of attachment.

### SUMMARY

Coil designs for reducing local heating of a panel are disclosed.

In one aspect, an actuator is described that includes a voice coil and a moving magnet assembly. The voice coil is attached to a panel extending in a plane. The voice coil includes a first portion and a second portion. The first portion of the voice coil includes a first plurality of windings arranged in a spiral extending parallel to the plane. The first plurality of windings spans a first dimension in a first direction parallel to the plane. The first plurality of windings is attached to the panel. The second portion of the voice coil includes a second plurality of windings extending perpendicular to the plane. The second plurality of windings spans a second dimension in the first direction. The first dimension is larger than the second dimension. The magnet assembly is suspended from the panel. The magnet assembly includes a magnet positioned within the second portion of the voice coil. The magnet assembly is configured to vibrate in a second direction perpendicular to the plane during operation of the actuator.

In some implementations, one or more of the following can be implemented either individually or in any feasible or suitable combination. The magnet assembly is configured to vibrate in response to alternating current being passed through the second portion of the voice coil during the operation of the actuator. The voice coil is made of a material that generates heat within the voice coil with the passage of the alternating current. The heat within the voice coil heats the panel during the operation of the transducer. The first plurality of windings are designed to spread the heat across the panel during the operation of the actuator to avoid heat concentration at a base of the second portion of the voice coil.

The second plurality of windings are arranged to form a tube with a uniform cross-section across a height of the second portion. The uniform cross-section has a rectangular shape with curved corners. In some examples, the uniform cross-section has a substantially rectangular shape. In certain examples, the uniform cross-section has a circular shape. In a few examples, the uniform cross-section is has an oval shape.

The second portion of the voice coil has a wall that is perpendicular to the plane, the wall comprising two or more windings of the second plurality of windings. The two or more windings are arranged in spirals in corresponding planes that are parallel to the plane. The first plurality of windings has a first density in the first direction. The two or more windings have a second density in the first direction. The second density is higher than the first density. The second plurality of windings has a third density in the second direction. The third density is higher than the second density.

The magnet assembly further includes a cup in which the magnet is housed. The cup includes a magnetic back plate and magnetic side walls. The second portion of the coil is located in an air gap between the magnetic side walls and the magnet. The magnetic side walls are coupled to a frame arranged perpendicular to the plane via spring elements. The spring elements cause (e.g. enable) the suspension of the magnet assembly from the panel.

The panel can be a display panel. The display panel can be an organic light emitting diode (OLED) panel.

In another aspect, the actuator is a part of a mobile device. Such mobile device includes a housing, a display panel mounted in the housing, a voice coil, a magnet assembly. The voice coil is attached to the display panel in a plane. The voice coil includes a first portion and a second portion. The first portion of the voice coil includes a first plurality of windings arranged in a spiral extending parallel to the plane. The first plurality of windings span a first dimension in a first direction parallel to the plane. The first plurality of windings is attached to the display panel. The second portion of the voice coil includes a second plurality of windings extending perpendicular to the plane. The second plurality of windings spans a second dimension in the first direction. The first dimension is larger than the second dimension. The magnet assembly is suspended from a frame of the display panel. The magnet assembly includes a magnet positioned within the second portion of the voice coil. The electronic control module is electrically coupled to the voice coil and programmed to energize the voice coil to cause a motion along the second direction of the magnet assembly relative to the voice coil such that the display panel vibrates at frequencies and amplitudes sufficient to produce an audio response from the display panel.

In some implementations, one or more of the following can be implemented either individually or in any feasible or suitable combination. The second plurality of windings is arranged to form a tube with a uniform cross-section across a height of the second portion. The uniform cross-section has a substantially rectangular shape with curved corners. The second portion of the voice coil has a wall that is perpendicular to the plane. The wall includes two or more windings of the second plurality of windings. The two or more windings are arranged in spirals in corresponding planes that are parallel to the plane. The first plurality of windings has a first density in the first direction. The two or more windings have a second density in the first direction. The second density is higher than the first density. The second plurality of windings has a third density in the second direction. The third density is higher than the second density.

The magnet assembly further includes a cup in which the magnet is housed. The cup includes a magnetic back plate and magnetic side walls. The second portion of the coil is located in an air gap between the magnetic side walls and the magnet. The magnetic side walls are coupled to a frame arranged perpendicular to the plane via spring elements. The spring elements allow/enable the suspension of the magnet assembly from the display panel.

The display panel can be an organic light emitting diode (OLED) panel.

The subject matter described herein provides many advantages. For example, the structure of the voice coil can facilitate spreading of heat generated by the voice coil across a substantial area of the panel, thereby eliminating localized heating of the display panel at a point of attachment between the voice coil and the display panel, and thus also the distortions in display caused by such localized heating.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 illustrates a perspective view of a mobile device that features a panel audio transducer.

FIG. 2 illustrates a cross-sectional view schematic view of the mobile device.

FIG. 3 is a cross-sectional view of an implementation of an actuator (also referred to as a moving magnet actuator) in the panel audio transducer.

FIG. 4 illustrates a perspective view of one example of the voice coil of the actuator.

FIG. 5 is a front view of the voice coil.

FIG. 6 is a top view of the voice coil.

FIG. 7 is a schematic diagram of an embodiment of an electronic control module for providing drive signals to the actuator.

Like reference symbols in the various drawings indicate like elements.

### DETAILED DESCRIPTION

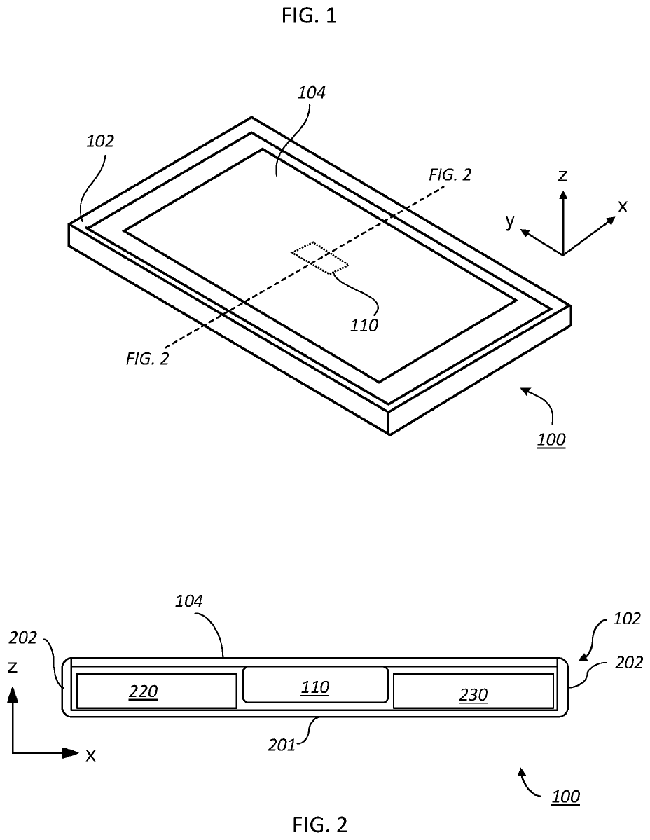

FIG. 1 is a perspective view of a mobile device 100 that features a panel audio transducer. The mobile device (e.g., a smartphone) 100 includes a device chassis 102 and a display panel 104 including a flat panel display (e.g., an OLED or LCD display panel) that integrates a panel audio transducer composed of the display panel 104 and an actuator (which can also be referred to as a moving magnet actuator) 110 mechanically coupled to the back surface of the display panel 104. The mobile device 100 interfaces with a user in a variety of ways, including by displaying images, receiving touch input via a touch feature of the display panel 104, and producing audio and haptic output. Generally, as part of a panel audio transducer, the vibrating panel generates human-audible sound waves, e.g., in the range of 20 Hz to 20 kHz. In addition to producing sound output, mobile device 100 can also produces haptic output via the display panel 104. For example, the haptic output can correspond to vibrations in the range of 150 Hz to 300 Hz.

The mobile device 100 can have a depth (along the z-axis) of approximately 10 mm or less, a width (along the x-axis) of 60 mm to 80 mm (e.g., 68 mm to 72 mm), and a height (along the y-axis) of 100 mm to 160 mm (e.g., 138 mm to 144 mm). Accordingly, compact and efficient actuators for driving the display panel 104, such as those described above, are desirable.

FIG. 2 is a cross-sectional view schematic view of the mobile device 100. This cross-section shows that the device chassis 102, which has a back plate 201 and side walls 202, and the display panel 104 form an enclosure for housing components of the mobile device 100 including the actuator 110, a battery 230 and an electronic control module 220.

Various implementations of the actuator 110 are described below. Generally, the actuator 110 is sized to fit within a volume constrained by other components housed in the mobile device 100, including the electronic control module 220 and the battery 230. The electronic control module 220 provides control signals to the actuator 110, causing the actuator 110 to produce audio and/or haptic output.

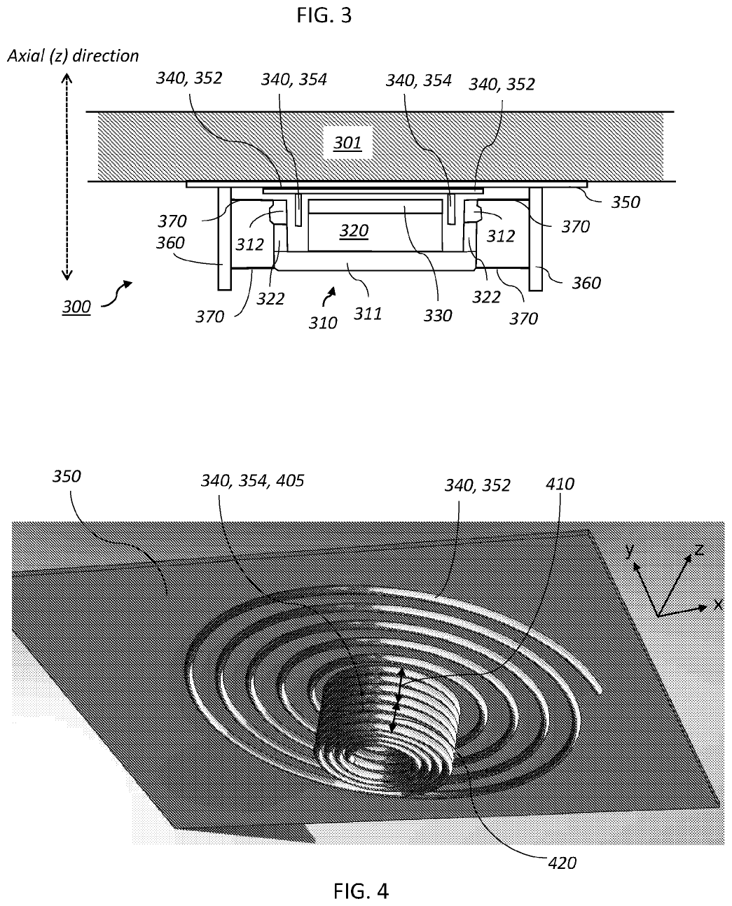

FIG. 3 is a cross-sectional view of an implementation of an actuator 300 in a panel audio transducer. The actuator 300 is suitable for use in the mobile device 100. The actuator 300 includes a magnet 320 (which can also be referred to as the permanent magnet), shaped as a thin disc, and a coil 340. The coil 340 is connected to a plate (which can also be referred to as the actuator coupling plate) 350 which, when fully assembled, is attached to a panel 301 of the panel audio transducer. The voice coil 340 includes a first portion 352 that includes multiple windings would in a spiral in a common plane that extends parallel to the plane of the plate 350, and a second portion 354 that includes windings extending in a stack perpendicular to the plane, one example of which is shown in FIG. 4. The windings in the first portion 352 of the voice coil 340 are spaced apart and extend over a larger area compared to second portion 354. This allows the first portion 354 to spread the heat generated in the voice coil 340 across the plate 350—and thus the panel 301—during the operation of the actuator 300. By spreading the heat, the coil reduces heat concentration at a base of the second portion 354 of the voice coil 340. Reducing of localized heating can reduce (e.g., prevent) distortions in display caused by such localized heating.

Returning to the structure of actuator 300, the magnet 320 is housed in a cup 310 composed of a soft magnetic back plate 311 (e.g., a ferrous plate) and side walls composed of a magnetic portion 322 and a soft magnetic caps 312. The magnet 320 is sandwiched between the base (i.e., soft magnetic back plate 311) of the cup 310 and a soft magnetic top plate 330. The top plate 330 can indicate a pole of the magnet 320, and can be referred to as the pole piece. The cup 310 is attached, via spring elements 370, to a frame 360, which is attached to the plate 350. The spring elements 370 suspend the cup 310, the magnet 320 and the top plate 330 relative to the second portion 354 of the coil 340. An air gap exists between the side walls of cup 310 and the magnet 320 and the top plate 330. The second portion 354 of the coil 340 is positioned in the air gap.

Generally, components of the actuator 300—including the coil 340, the magnet 320, and the cup 310—can be continuously rotationally symmetric about the axis (i.e., cylindrical in shape) or can have discrete or no rotational symmetry about the axis. For example, the actuator components with discrete rotational symmetry can have a square, rectangular, or other polygon-shaped footprint in the plane orthogonal to the axis. Such shapes can have sharp, beveled, or filleted corners.

The actuator shown in FIG. 3 can be compact. For example, the thickness of the actuator in the axial direction can be on the order of a few mm, e.g., 10 mm or less, 8 mm or less, 5 mm or less, 4 mm or less, 3 mm or less, 2 mm or less. Accordingly, in certain implementations, the second portion 354 of the coil 340 can have an axial length of about 2-6 mm, where approximately half its length sits in the air gap of the magnet assembly and approximately half stands proud of the air gap. The lateral dimensions of the actuator 300 can also be relatively small. For example, the outer axially magnetized magnet 322 can have a lateral diameter (i.e., the diameter orthogonal to the symmetry axis) of 20 mm or less (e.g., 15 mm or less, 12 mm or less, 10 mm or less, 8 mm or less, 7 mm or less, 6 mm or less, 5 mm or less). The first portion 352 of the

In general, the magnet 320 can be formed from a material than can be permanently magnetized, such as rare earth magnet materials. Some such rare earth magnet materials include neodymium iron boron, samarium cobalt, barium ferrite, and strontium ferrite.

The soft magnetic pole piece 330 and cup portions 311, 312 and/or 322 of the cup can be formed from a material or materials that are readily magnetized in the presence of an external magnetic field and demagnetized when the external field is removed. Typically, such materials have high magnetic permeability. Examples of such materials include high carbon steel and vanadium permendur. Accordingly, the soft magnetic plate and yoke serve to guide the magnetic flux lines from the axially magnetized magnets across the air gap.

The magnet 320 is typically axially magnetized. In other words, the poles of the magnet 320 are aligned along the axial direction. When the coil 340 is energized, the coil 340 generates a magnetic field that interacts with the field of the magnet 320, axially displacing the magnetic cup 310, the magnet 320, and the top plate 330 relative to the coil 340. The magnet 322 can be, for example, axially or radially magnetized.

FIG. 4 illustrates a perspective view of one example of the voice coil 340 of the actuator 300. The voice coil 340 includes a first portion 352 that includes windings arranged in a spiral extending parallel to a plane of the plate 350, and a second portion 354 that includes windings extending perpendicular to that plane.

The spiral shape of the first portion 352 of the coil 340 is a curve— in the plane of the plate 350—that winds around the base of the second portion 354 of the coil 340 at a continuously increasing distance from the base. The coil 340 is an electrically-conducting wire, through which alternating electrical current is passed to generate magnetic field. As noted above, the spiral windings in the first portion 352 of the voice coil 340 are designed to spread the heat—generated in the voice coil 340 by passage of the alternating current—across the plate 350 and thus the panel 301 during the operation of the actuator 300. For example, the coil windings can be spread apart and spread over a sufficiently large area to dissipate heat generated by the coil. Such spreading of heat reduces heat concentration at a base of the second portion 354 of the voice coil 340. Avoidance of localized heating can prevent distortions in display caused by such localized heating. Although spiral windings shown in the first portion 352 of the coil 340 form a circular spiral, in certain implementations the first portion 352 of the coil 340 can form other spiral shapes such as an elliptical spiral, a rectangular spiral, a square-shaped spiral, or any other appropriate spiral shape. In some implementations, the spiral can be mathematically described by one of several different spiral shapes, such as an arithmetic spiral (also referred to as Archimedian spiral), a hyperbolic spiral, a parabolic spiral with one or more branches, a logarithmic spiral (also referred to as an equiangular spiral or a growth spiral), a Euler spiral (also referred to as a spiro, clothoid, or Cornu spiral), any other one or more spirals, and/or any combination thereof.

The first portion 352 of the coil 340 is attached to a surface of the plate 350, e.g., using an adhesive. Electrical leads to and from the first portion 352 of the coil 340 can be attached to the plate 350, allowing electrical access to the coil 340.

The second portion 354 of the coil 340 has the form of a tube 405. The tube 405 has a uniform cross-section across a height of the second portion 354. The uniform cross-section is a circle for the shown implementation. In some other implementations, the uniform cross-section of the tube 405 is an oval. In certain implementations, the uniform cross-section of the tube 405 is a rectangle, e.g., with curved corners. In other implementations, the uniform cross-section of the tube 405 is substantially rectangular. The windings forming the tube 405 are wound in a tight spiral and stacked on top of each other so that the tube 405 extends perpendicular to the plane of the plate 350 in the z-direction.

The windings of the coil 340 in the tube 405 in the z direction are stacked on top of each other, as well as adjacent to each other (e.g., physically touch each other), as shown. Within the tube 405, the spacing between adjacent windings of the coil 340 in and throughout the z direction is less than the spacing between adjacent curves of the coil 340 in any direction in the x-y plane. For instance, within the tube 405, adjacent windings of the coil 340 in and throughout the z direction can be in contact with each other or can be spaced apart by 0.1 mm or less. Accordingly, depending on the wire gauge of the windings, they can have a density in a range of 10 windings per mm or more (e.g., up to 15 windings per mm). Laterally, in the x-y plane, the windings in coil 340 can be in contact with each other (e.g., in second portion 354) or can be spaced apart by 0.01 mm or more (e.g., in the first portion 352), e.g., up to about 1 mm. In the first portion 352, the winding density can be in a range from 0.2 windings per mm to about 10 windings per mm as measured in a radial direction from a center of the coil.

Different regions of the tube 405—such as region 410 (which extends between the air gap and the plate 350) and region 420 (which extends into the air gap)—can have different winding densities in the z direction. The winding density in the z direction is lower for the region 410 than for the region 420. For example, the winding density in the z direction for the region 410 is 10 windings per millimeter, and the winding density in the z direction for the region 420 is 1 windings per millimeter. The relative winding density of the region 410 and the region 420 vary depending on the magnetic field strength and corresponding current load needed to drive the actuator 300.

By using a coil with a higher winding density in spaces where the magnetic field from the magnet assembly is focused (e.g., within the air gap), it is possible to get a larger shove (i.e., force) from the actuator, compared to a coil where the winding density is uniform. Here, the “shove” refers to the value Bl²/R, where B is the magnetic field strength from the magnet assembly at the coil, l is the length of coiled wire in the magnetic field, and R is the resistance of the coil. Accordingly, by using a coil with a high winding density in a region where the magnetic field is focused, and a low winding density where it isn't, Bl is maintained while R is reduced compared to a coil having uniform, high winding density. The result is a larger shove compared to the coil with uniform winding density.

The relative axial length of the region 410 and the region 420 can vary. These regions 410 and 420 can have axial lengths that are approximately equal, as shown. Alternatively, the region 410 can be longer or shorter than the region 420, depending on the design of the actuator. In some implementations, each region has an axial length in a range from about 0.5 mm to about 3 mm.

The coil 340 is made of an electrically conductive material, such as copper. In other implementations, the coil 340 can be made of any other electrically conducting material such as silver, gold, aluminum, zinc, nickel, brass, bronze, iron, platinum, steel, lead, or stainless steel. Generally, the coil 340 has sufficient mechanical stiffness—e.g., mechanical stiffness more than a threshold value—so that the coil 340 can be self-supported to maintain its shape. Mechanical stiffness is the resistance of an elastic body, such as the coil 340, to deflection or deformation by an applied force.

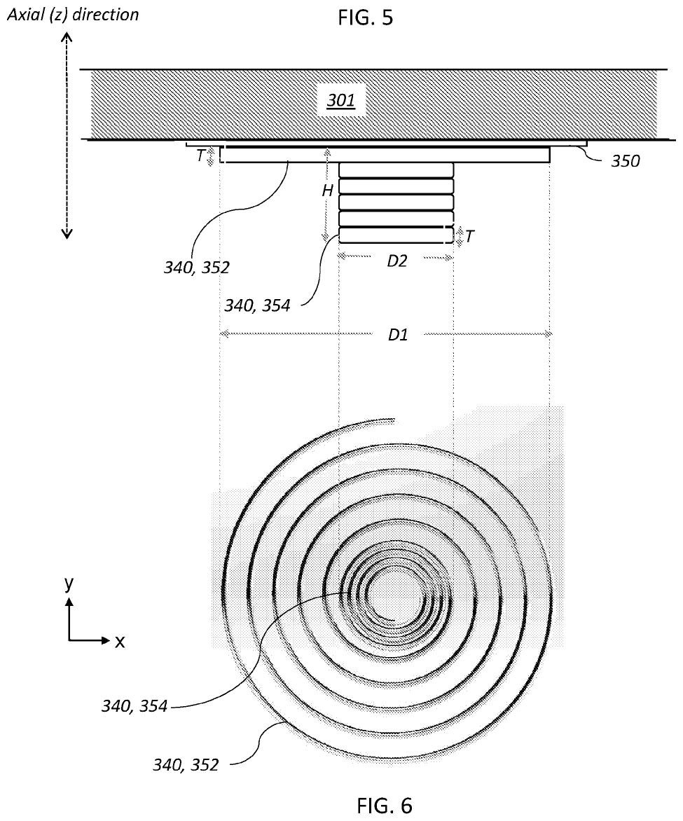

FIG. 5 is a front view of the voice coil 340. This drawing shows various dimensions of the coil 340. The coil 340 has a thickness (or diameter, where the cross-section of the coil 340 is circular) T. The first portion 352 of the coil 340 has a diameter D1. The second portion 354 of the coil 340 has a diameter D2, and a height H. Generally, the coil's dimensions are selected to accommodate the magnet assembly of the actuator and provide a magnetic field strength appropriate for operation of the actuator. For example, T has a value between 0.1 mm and 1 mm. D1 can have a value that is 25 mm or less (e.g., 22 mm or less, 20 mm or less, 15 mm or less, 12 mm or less, 10 mm or less, 8 mm or less, 7 mm or less, 6 mm or less, 5 mm or less, or the like). D2 can have a value that is 10 mm or less (e.g., 8 mm or less, 6 mm or less, 4 mm or less, 2 mm or less, or the like). H can have a value between 2 mm and 5 mm.

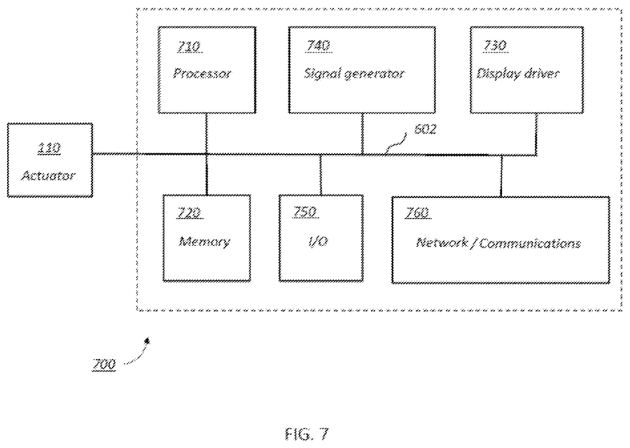

FIG. 6 is a top view of the voice coil 340. The first portion 352 of the voice coil 340 has a spiral shape, whereby the coil 340 has a curve that winds around the base of the second portion 354 of the coil 340 at a continuously increasing distance from that base. The spiral windings in the first portion 352 of the voice coil 340 are designed to spread the heat generated in the voice coil 340 across the plate 350 and thus the panel 301 during the operation of the actuator 300 so as to reduce heat concentration at a base of the second portion 354 of the voice coil 340. Reduction of localized heating can prevent distortions in display caused by such localized heating. Although spiral windings are shown in the first portion 352, in alternate implementations the first portion 352 can have other shapes suitable for spreading the heat.

As noted above, mobile devices and other devices that utilize a moving magnetic actuator in a panel audio loudspeaker use an electronic control module to control operation of the actuator. In general, electronic control modules are composed of one or more electronic components that receive input from one or more sensors and/or signal receivers, e.g., of the mobile device, process the input, and generate and deliver signal waveforms that cause actuator 510 to provide a suitable haptic response. Referring to FIG. 7, an exemplary electronic control module 700 of a mobile device 100, such as the mobile phone, includes a processor 710, a memory 720, a display driver 730, a signal generator 740, an input/output (I/O) module 750, and a network/communications module 760. These components are in electrical communication with one another (e.g., via a signal bus 702) and with the actuator 110.

Processor 710 may be implemented as any electronic device capable of processing, receiving, or transmitting data or instructions. For example, processor 610 can be a microprocessor, a central processing unit (CPU), an application-specific integrated circuit (ASIC), a digital signal processor (DSP), or combinations of such devices.

Memory 720 has various instructions, computer programs or other data stored thereon. The instructions or computer programs may be configured to perform one or more of the operations or functions described with respect to the mobile device. For example, the instructions may be configured to control or coordinate the operation of the device's display via display driver 730, signal generator 740, one or more components of I/O module 750, one or more communication channels accessible via network/communications module 760, one or more sensors (e.g., biometric sensors, temperature sensors, accelerometers, optical sensors, barometric sensors, moisture sensors and so on), and/or actuator 110.

Signal generator 740 is configured to produce AC waveforms of varying amplitudes, frequency, and/or pulse profiles suitable for actuator 110 and producing acoustic and/or haptic responses via the actuator. Although depicted as a separate component, in some implementations, signal generator 740 can be part of processor 710. In some implementations, signal generator 740 can include an amplifier, e.g., as an integral or separate component thereof.

Memory 720 can store electronic data that can be used by the mobile device. For example, memory 720 can store electrical data or content such as, for example, audio and video files, documents and applications, device settings and user preferences, timing and control signals or data for the various modules, data structures or databases, and so on. Memory 720 may also store instructions for recreating the various types of waveforms that may be used by signal generator 740 to generate signals for actuator 110. Memory 720 may be any type of memory such as, for example, random access memory, read-only memory, Flash memory, removable memory, or other types of storage elements, or combinations of such devices.

As briefly discussed above, electronic control module 700 may include various input and output components represented in FIG. 7 as I/O module 750. Although the components of I/O module 750 are represented as a single item in FIG. 7, the mobile device may include a number of different input components, including buttons, microphones, switches, and dials for accepting user input. In some embodiments, the components of I/O module 750 may include one or more touch sensor and/or force sensors. For example, the mobile device's display may include one or more touch sensors and/or one or more force sensors that enable a user to provide input to the mobile device.

Each of the components of I/O module 750 may include specialized circuitry for generating signals or data. In some cases, the components may produce or provide feedback for application-specific input that corresponds to a prompt or user interface object presented on the display.

As noted above, network/communications module 760 includes one or more communication channels. These communication channels can include one or more wireless interfaces that provide communications between processor 710 and an external device or other electronic device. In general, the communication channels may be configured to transmit and receive data and/or signals that may be interpreted by instructions executed on processor 710. In some cases, the external device is part of an external communication network that is configured to exchange data with other devices. Generally, the wireless interface may include, without limitation, radio frequency, optical, acoustic, and/or magnetic signals and may be configured to operate over a wireless interface or protocol. Example wireless interfaces include radio frequency cellular interfaces, fiber optic interfaces, acoustic interfaces, Bluetooth interfaces, Near Field Communication interfaces, infrared interfaces, USB interfaces, Wi-Fi interfaces, TCP/IP interfaces, network communications interfaces, or any conventional communication interfaces.

In some implementations, one or more of the communication channels of network/communications module 760 may include a wireless communication channel between the mobile device and another device, such as another mobile phone, tablet, computer, or the like. In some cases, output, audio output, haptic output or visual display elements may be transmitted directly to the other device for output. For example, an audible alert or visual warning may be transmitted from the electronic device 700 to a mobile phone for output on that device and vice versa. Similarly, the network/communications module 760 may be configured to receive input provided on another device to control the mobile device. For example, an audible alert, visual notification, or haptic alert (or instructions therefore) may be transmitted from the external device to the mobile device for presentation.

While the panel audio transducer described above is incorporated into a mobile phone, more generally, the actuator technology disclosed herein can be used in other panel audio systems, e.g., designed to provide acoustic and/or haptic feedback. Generally, the panel may be a display system, for example based on OLED or LCD technology. The panel may be part of a smartphone, tablet computer, or wearable devices (e.g., smartwatch or head-mounted device, such as smart glasses).

Furthermore, while the examples describe above feature an inertial system in which the magnet assembly is suspended by spring elements from a rigid frame that is bonded to the panel, other arrangements are possible. For instance, the coils described herein can be used in actuators where the magnet assembly is mechanically grounded, e.g., by rigid attachment to the frame.

Although a few implementations have been described in detail above, other implementations and/or modifications are possible. Other implementations may be within the scope of the following claims.

What is claimed is:

1. An actuator comprising:
a voice coil attached to a panel extending in a plane, the voice coil comprising a first portion and a second portion, the first portion of the voice coil comprising a first plurality of windings arranged in a spiral extending parallel to the plane, the first plurality of windings spanning a first dimension in a first direction parallel to the plane, the first plurality of windings being attached to the panel, the second portion of the voice coil comprising a second plurality of windings extending perpendicular to the plane, the second plurality of windings spanning a second dimension in the first direction, the first dimension being larger than the second dimension; and
a magnet assembly suspended from the panel, the magnet assembly comprising a magnet positioned within the second portion of the voice coil, the magnet assembly configured to vibrate in a second direction perpendicular to the plane during operation of the actuator.

2. The actuator of claim 1, wherein the magnet assembly is configured to vibrate in response to alternating current being passed through the second portion of the voice coil during the operation of the actuator.

3. The actuator of claim 2, wherein:
the voice coil is made of a material that generates heat within the voice coil with the passage of the alternating current, the heat within the voice coil heating the panel during the operation of the transducer; and
the first plurality of windings are designed to spread the heat across the panel during the operation of the actuator to avoid heat concentration at a base of the second portion of the voice coil.

4. The actuator of claim 1, wherein the second plurality of windings are arranged to form a tube with a uniform cross-section across a height of the second portion.

5. The actuator of claim 4, wherein the uniform cross-section has a rectangular shape with curved corners.

6. The actuator of claim 4, wherein the uniform cross-section has a substantially rectangular shape.

7. The actuator of claim 4, wherein the uniform cross-section has a circular shape.

8. The actuator of claim 4, wherein the uniform cross-section is has an oval shape.

9. The actuator of claim 1, wherein the second portion of the voice coil has a wall that is perpendicular to the plane, the wall comprising two or more windings of the second plurality of windings, the two or more windings being arranged in spirals in corresponding planes that are parallel to the plane.

10. The actuator of claim 9, wherein:
the first plurality of windings has a first density in the first direction;
the two or more windings have a second density in the first direction, the second density being higher than the first density.

11. The actuator of claim 10, wherein the second plurality of windings has a third density in the second direction, the third density being higher than the second density.

12. The actuator of claim 1, wherein the magnet assembly further comprises a cup in which the magnet is housed, the cup comprising a magnetic back plate and magnetic side walls, the second portion of the coil being located in an air gap between the magnetic side walls and the magnet.

13. The actuator of claim 12, wherein the magnetic side walls are coupled to a frame arranged perpendicular to the plane via spring elements, the spring elements causing the suspension of the magnet assembly from the panel.

14. The actuator of claim 1, wherein the panel comprises a display panel.

15. The actuator of claim 14, wherein the display panel is an organic light emitting diode (OLED) panel.

16. A mobile device comprising:
a housing;
a display panel mounted in the housing;
a voice coil attached to the display panel in a plane, the voice coil comprising a first portion and a second portion, the first portion of the voice coil comprising a first plurality of windings arranged in a spiral extending parallel to the plane, the first plurality of windings spanning a first dimension in a first direction parallel to the plane, the first plurality of windings being attached to the display panel, the second portion of the voice coil comprising a second plurality of windings extending perpendicular to the plane, the second plurality of windings spanning a second dimension in the first direction, the first dimension being larger than the second dimension;
a magnet assembly suspended from a frame of the display panel, the magnet assembly comprising a magnet positioned within the second portion of the voice coil; and
an electronic control module electrically coupled to the voice coil and programmed to energize the voice coil to cause a motion along the second direction of the magnet assembly relative to the voice coil such that the display panel vibrates at frequencies and amplitudes sufficient to produce an audio response from the display panel.

17. The mobile device of claim 17, wherein:
the second plurality of windings are arranged to form a tube with a uniform cross-section across a height of the second portion; and
the uniform cross-section has a substantially rectangular shape with curved corners.

18. The mobile device of claim 17, wherein:
the second portion of the voice coil has a wall that is perpendicular to the plane, the wall comprising two or more windings of the second plurality of windings, the two or more windings being arranged in spirals in corresponding planes that are parallel to the plane;
the first plurality of windings has a first density in the first direction;
the two or more windings have a second density in the first direction, the second density being higher than the first density; and
the second plurality of windings has a third density in the second direction, the third density being higher than the second density.

19. The mobile device of claim 17, wherein:
the magnet assembly further comprises a cup in which the magnet is housed, the cup comprising a magnetic back plate and magnetic side walls, the second portion of the coil being located in an air gap between the magnetic side walls and the magnet; and
the magnetic side walls are coupled to a frame arranged perpendicular to the plane via spring elements, the spring elements causing the suspension of the magnet assembly from the display panel.

20. The mobile device of claim 17, wherein the display panel is an organic light emitting diode (OLED) panel.
